(19) United States
(12) Patent Application Publication
(10) Pub. No.: US 2012/0191658 A1
(43) Pub. Date: Jul. 26, 2012

(54) DATA PROTECTION

(76) Inventors: Gopakumar Ambat, Bangalore (IN); Arun Chandra Mohanty, Bangalore (IN)

(21) Appl. No.: 13/384,837

(22) PCT Filed: Mar. 10, 2010
(86) PCT No.: PCT/IN2010/000139

§ 371 Date: Jan. 19, 2012

(51) Int. Cl. G06F 17/30

(52) U.S. Cl. 707/654; 707/E17.007; 707/E17.005

(57) ABSTRACT

Presented is a method of protecting data. The method includes recognizing a newly created data file, providing at least one data protection policy for selection by a user, obtaining a user input for selecting at least one data protection policy, applying the selected data protection policy to the newly created data file, creating a backup copy of the newly created data file based on the applied data protection policy, and storing the backup copy of the newly created data file based on the applied data protection policy.

### BACKGROUND

Data protection in an enterprise environment is a challenging task that is routinely faced by an administrator managing the IT infrastructure of an establishment. Considering that a large organization may have a plethora of applications and devices, storing and protecting critical data becomes key to managing and running a successful enterprise. It's not surprising therefore that various vendors have come out with a multitude of data protection software or backup software to fulfill an organization's requirement to safeguard its data. The tools available in the marketplace today offer various kinds of data protection solutions. These could be local backup and recovery type, online web-based backup, removable storage backup, etc.

Data storage decisions associated with critical applications, such as an ERP application, are usually made by a storage administrator, who takes a call on what data needs to be backed up and when. However, protecting of data on systems or devices owned by individual users presents a different challenge. Individual users may not have the time or resources to decide what data needs to be backed up and when. Even if willing, there is no solution available which makes a user's task easier and allows control on how and what data is to be protected. In such a scenario, with data protection being a distinct secondary activity, there is a very likely chance that critical data may escape protection.

### BRIEF DESCRIPTION OF THE DRAWINGS

For a better understanding of the invention, embodiments will now be described, purely by way of example, with reference to the accompanying drawings, in which:

FIG. 1 shows a flow chart of a computer-implemented method of protecting data according to an embodiment

FIG. 2 shows a block diagram of a computer system upon which an embodiment may be implemented.

### DETAILED DESCRIPTION OF THE INVENTION

In the present scenario, data protection in an enterprise environment is an extremely complicated task considering that data may be distributed across various elements that constitute the enterprise. Traditional data protection software focuses on the routine tasks of data protection, i.e. how to read data from a data source and transfer it to a target.

Embodiments of the present invention provide a method of data protection that ties-in data protection to data creation. The embodiments described below provide a radical shift from the way the current data protection or archiving software protect data. While the traditional file system protection software looks at a data protection area where the data should be backed up, the present embodiments look at the form and characteristics of the data before applying data protection policies. Embodiments take the onus of data protection closer to the data source and to the data creator or modifier than any traditional data protection software. The user who created the data in the first place becomes, a key participant in data protection.

The embodiments of the present invention provide methods, computer executable code and a graphical user interface for protecting data.

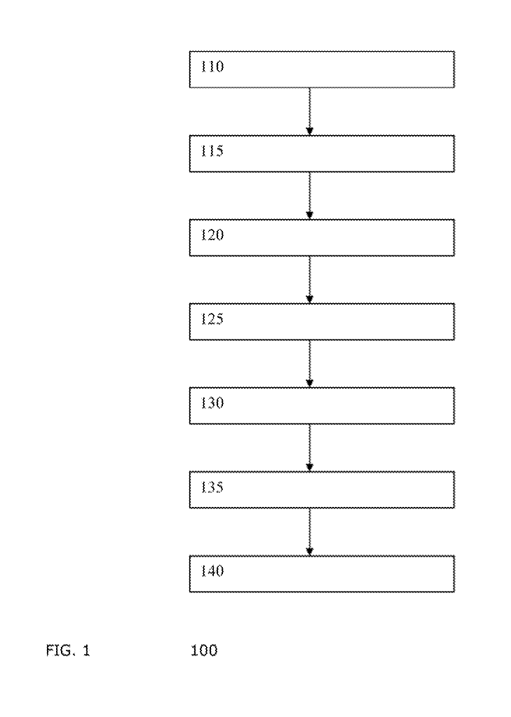

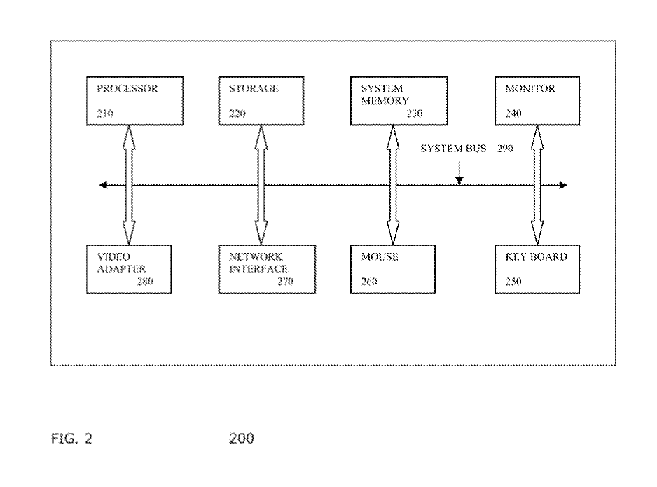

FIG. 1 shows a flow chart of a method 100 for protecting data according to an embodiment. The method 100 may be performed on a computer system (or a computer readable medium), such as, but not limited to, as illustrated in FIG. 2.

The method begins in step 110. In step 110, a newly created data file is recognized. For example, if a new Microsoft Word document file has been created, the method recognizes the same. The recognition of a newly created data file also includes recognition of a modified or an edited data file. It means, if a newly created data file is modified at a later date or an earlier pre-existing data file is modified or edited at a date or time subsequent to its creation, the method recognizes such modified file as well.

For the sake of clarity, it is specified that the word “data file” includes any computer readable file or format that contains data.

The recognition of a newly created data file may involve automatic recognition by a computer system or a user-input recognition. To illustrate, a computer system may have a computer executable program that automatically recognizes the creation (and/or modification) of a newly created data file. Alternatively, a user may initiate a request for saving (for example, by a “save” command) a newly created data file that results in its recognition by the method. Thus, a newly created data file is recognized upon recognition of a request to save the newly created data file.

In step 115, after it has been determined that a new file has been created, the method provides at least one data protection policy for selection by a user. The method may also provide a multiple number of data protection policies for selection by a user. A data protection, policy defines among many other things, how a data in a file is handled, saved and stored by an organization. To illustrate, the data protection policy of an organization may enumerate various rules and guideless applicable to the emails generated within the organization. For example, the policy may provide separate rules for emails generated by different people (a clerk, a manager, a CEO, etc) within the organization. These rules could relate to access of emails, saving of emails, storage of emails, etc.

The method provides a user with data protection policies available to him/her for selection. The data protection policies available to a user may be pre-defined (for example, by an administrator). Alternatively, a user may modify the pre-existing policies or define new ones. The new policies may be saved for later use and application, and offered to a user at a subsequent selection stage. To illustrate, if the method recognizes that a Microsoft Word document file has been created, it may offer to a user all pre-existing (administrator defined or user-defined) policies for selection. It may also offer an option to modify, add and/or delete user-defined policies. For example, in case of a new or modified Microsoft document, a user may be offered an existing policy to create a backup copy of the document for thirty days. Alternatively, the user may also have an option to add a data protection policy, say, to create a backup of the file for sixty days. The newly added policy would be saved by the method and offered to a user for selection at a subsequent data policy selection stage.

In step 120, the method obtains a user input for selecting at least one data protection policy. In one embodiment, a user who makes the selection is the user who created the new (or an existing) data file in the first place. The method allows the creator (or modifier) of a data file to define, specify and select a data protection policy of his or her choice for applying to a newly created (or modified) data file.

A user selects a data protection policy from the options presented to him or her in step 115. The method allows a user to select the data protection policy of his or her choice, and the user may select a policy depending on type of the data in the data file. To illustrate, a user may make an evaluation of the critical nature of data in the data file. For example, if the data in the data file is marked “confidential”, the user may regard the data relatively more critical than a file with data marked otherwise. In such a case, the user may like to select a data policy that corresponds with critical “confidential” nature of data in the data file. Therefore, if a user is provided with an option to select between two policies: one offering a backup of the data file, with secure access on a remote system and the other providing a backup on the local system with no security, the user may prefer to select the first data protection policy as it would meet his or her evaluation of the nature or type of data in the data file.

The data protection policy selected by a user is applied to the newly created data file in the form of one or more user defined tags. The application of a data protection policy in the form of a tag or tags makes the task of selecting a data protection policy easier for a user. A user need not remember the policy details, if he or she could identify the tag or tags associated with the policy. To illustrate, a policy offering a backup of the data file, with secure access on a remote system may be given a tag “secure remote” and another policy providing a backup on the local system with no security may be tagged as “unsecure local”. The method may allow a user to view the policy behind a tag prior to making a selection.

The method provides a graphical user interface (GUI) for obtaining a user input for obtaining a user input for selecting at least one data protection policy. The GUI for obtaining the user input may be integrated with means for creating a new data file or modifying an existing data file. To illustrate, let us assume a new document file is created using Microsoft Word. In such case, the method may provide a GUI in the form of a pop-up window, which may get activated when a user tries to save a newly created (or modified) document, providing data protection policies to a user for making a selection. In the alternative, a tag or tags associated with a data protection policy may provided as menu options, a drop down list, etc for selection by a user.

As mentioned earlier, the method allows a user to select a data protection policy for applying to a data file that has been created earlier, i.e. a pre-existing data file. A user input may be obtained for selecting a data protection policy upon modification of a newly created data file. The method may recognize that an existing file has been modified and upon such recognition offer to a user (who may have modified the file), an option to continue with existing data protection policy or select another policy for application to the modified data file. The selected data protection policy may be different from the data protection policy applied to the previously created data file.

The method also allows a user to select a data protection policy upon lapse of a certain pre-defined period of time, from creation of a newly created data file. To illustrate, once a user has created a new data file and selected a data protection policy for the same, the user may like to revisit the selection and modify the data protection policy selected earlier, after a certain period of time, defined by the user (for example, six months).

In step 125, the method allows application of selected data protection policy to a newly created (or modified) data file. Once a user selects a data protection policy in step 120, the method applies it to the data file. To illustrate, from an earlier example, if user selects a policy offering a backup of the data file, with secure access on a remote system, the method applies the same accordingly.

As mentioned earlier, a data protection policy may be applied to a newly created (or modified) data file in the form of one or more defined tags. These tags may be user defined. For example, a policy offering a backup of the data file, with secure access on a remote system, may be given a tag “secure remote” or the like. Therefore, a user has an option to define tags as well as the policies associated with those tags.

In step 130, the method creates a backup copy of the newly created (or modified) data file based on the applied data protection policy. To illustrate, if the data protection policy specifies creation of a back up copy of a newly created file on a remote server, the method creates a copy accordingly.

In step 135, the method stores a backup copy of the newly created data file based on the applied data protection policy. The backup copy of the newly created data file may be stored on a local or a remote computer readable medium. To illustrate, if the data protection policy specifies storing a back up copy of a newly created file on a remote server for a period of one year, the method stores a copy accordingly.

In step 140, the method comes to an end.

FIG. 2. shows a block diagram of a computer system 200 upon which an embodiment may be implemented. The computer system 200 includes a processor 210, a storage medium 220, a system memory 230, a monitor 240, a keyboard 250, a mouse 260, a network interface 220 and a video adapter 280. These components are coupled together through a system bus 290.

The storage medium 220 (such as a hard disk) stores a number of programs including an operating system, application programs and other program modules. A user may enter commands and information into the computer system 200 through input devices, such as a keyboard 250, a touch pad (not shown) and a mouse 260. The monitor 240 is used to display textual and graphical information.

An operating system runs on processor 210 and is used to coordinate and provide control of various components within personal computer system 200 in FIG. 2. Further, a computer program, such as, but not limited to, OpenView Data Protector and HP Data Protector, both from Hewlett-Packard Company, may be used on the computer system 200 to implement the various embodiments described above.

It would be appreciated that the hardware components depicted in FIG. 2 are for the purpose of illustration only and the actual components may vary depending on the computing device deployed for implementation of the present invention.

Further, the computer system 200 may be, for example, a desktop computer, a server computer, a laptop computer, or a wireless device such as a mobile phone, a personal digital assistant (PDA), a hand-held computer, etc.

The embodiment described provides a novel and effective way to integrate data protection with the process of data generation especially with respect to day to day user generated data on a user's system or device. The embodiments described look at data protection from the perspective of the data that needs protection rather than asking users to adhere to the specifications of any backup software.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A computer-implemented method of protecting data, the method comprising:
recognizing a newly created data file;
providing at least one data protection policy for selection by a user;
obtaining a user input for selecting at least one data protection policy;
applying the selected data protection policy to the newly created data file;
creating a backup copy of the newly created data file based on the applied data protection policy; and
storing the backup copy of the newly created data file based on the applied data protection policy.

2. A method according to claim 1, wherein the user input for selecting at least one data protection policy is obtained from a user who created the data file.

3. A method according to claim 1, further comprising providing a graphical user interface (GUI) for obtaining the user input for selecting at least one data protection policy.

4. A method according to claim 1, wherein the GUI for obtaining the user input for selecting at least one data protection policy is integrated with means for creating a new data file.

5. A method according to claim 1, wherein the at least one data protection policy is selected depending upon type of the newly created data file.

6. A method according to claim 1, wherein the at least one data protection policy for applying to the newly created data file is user defined.

7. A method according to claim 6, wherein the at least one data protection policy is applied to the newly created data file in the form of one or more user defined tags.

8. A method according to claim 1, further comprising obtaining a user input for selecting at least one data protection policy upon recognition of a modification in the newly created data file and applying the selected data protection policy to modified data file.

9. A method according to claim 1, wherein the at least one data protection policy applied to the modified data file is different from the data protection policy applied to the newly created data file.

10. A method according to claim 1, further comprising obtaining a user input for selecting a data protection policy upon lapse of a certain period of time from creation of the newly created data file.

11. A method according to claim 1, wherein the newly created data file is recognized upon recognition of a request to save the newly created data file.

12. A method according to claim 1, wherein the newly created data file includes a modified data file.

13. A system for protecting data, the system comprising:
means for recognizing a newly created data file;
means for providing at least one data protection policy for selection by a user;
means for obtaining a user input for selecting at least one data protection policy;
means for applying the selected data protection policy to the newly created data file;
means for creating a backup copy of the newly created data file based on the applied data protection policy; and
means for storing the backup copy of the newly created data file based on the applied data protection policy.

14. A computer program comprising computer program means adapted to perform all of the steps of claim 1 when said program is run on a computer.

15. A computer program according to claim 14 embodied on a computer readable medium.
